(19) United States
(12) Patent Application Publication
(10) Pub. No.: US 2006/0112801 A1
(43) Pub. Date: Jun. 1, 2006

(54) Method and device for cutting masks for glueing coverings

(76) Inventor: Eric Ganci, Marrakech (FR)

Correspondence Address: YOUNG & THOMPSON, 745 SOUTH 23RD STREET, 2ND FLOOR, ARLINGTON, VA, 22202, US

(21) Appl. No.: 10/528,432

(22) PCT Filed: Aug. 11, 2003
(86) PCT No.: PCT/FR03/02504

§ 371 Date: Nov. 1, 2005

(30) Foreign Application Priority Data
Sep. 18, 2002 (FR) 02/11537
Dec. 20, 2002 (FR) 02/16282

(51) Int. Cl. B26D 3/00

(52) U.S. Cl. 83/39

(57) ABSTRACT

The present invention provides a method of making a painting mask (13, 45 to 47, 301) for masking a portion of a vehicle, the method being characterized by the following steps: a) presenting a sheet material (6) over a sheet material support (2, 3, 202, 210); b) holding the sheet material in contact with a face (19, 26) of the sheet material support; c) cutting a mask out in the sheet material held in contact with the sheet material support by using a cutter tool (7, 8) that is moved relative to the support and/or the material; and d) separating the mask from the sheet material and/or the support.

The present invention relates to a method and to a device for making articles for masking portions of a vehicle in order to protect them from the soiling that is likely to arise as the result of paint being applied to some other portion of the vehicle,

The technical field of the invention is that of repairing motor vehicle bodywork.

Prior to painting at least a portion of the bodywork of a motor vehicle, it is known to protect its glazed portions by using masks that cover the glazed portions.

The term “glazed” portion is used herein essentially to mean those portions of the vehicle that are not painted, in particular the windshield, the back window, the left and right side windows, the glasses on the headlights and the back lights, the wing mirrors, and also other parts such as wheels, hubcaps, bumpers, or protective strips.

To perform this masking operation, it is general practice to use either salvaged paper or paper packaged in the form of a roll; for each member to be protected, an operator cuts out and/or tears manually a mask blank from the sheet of paper; the shape and the dimensions of the blank are determined approximately by the operator as a function of the shape and the dimensions of the member to be protected; the shape of a blank made in this way never corresponds exactly to the shape of the member it is to protect; the operator can then tear and/or crumple the blank in order to cause its outline to match coarsely to the outline of the member that is to be protected; such operations are lengthy and difficult, and they never provide a mask that matches exactly the shape of the part that is to be protected.

Document FR 2 600 917 describes the principle of a multilayer mask of disk shape for protecting an airplane porthole, without giving any indication concerning the materials, machines, and methods that are suitable for making it.

U.S. Pat. No. 4,789,579 proposes die cutting a Y-shaped mask to protect a vehicle bumper.

Application WO 02/29767 describes a mask for protecting a glazed and/or rounded portion of a vehicle, the mask being made out of a sheet material and having an outline that is curvilinear, at least in part and generally completely, the outline of the mask corresponding, once the mask has been deformed and pressed against said portion of the vehicle, to the outline of said portion; that document recommends using sheet material that is thin and lightweight, comprising a single layer and generally having no adhesive, being of a thickness of less than 200 micrometers (μm), and in particular of thickness lying in the range 20 μm to 80 μm; the material presents a weight per unit area of less than 200 grams per square meter (g/m²), and in particular a weight that lies in the range 20 g/m² to 80 g/m².

In order to avoid the mask deforming or becoming damaged while it is in contact with water- or oil-based substances, that document proposes using a material with both faces presenting high resistance to penetration by such substances, in particular paper that is grease-proofed on both faces, or kraft paper coated on both faces in polyethylene, or in a plastics material that withstands the solvents used for the vehicle paint.

That document also describes a method of making such masks, in which a stack is made of a plurality of sheets of said material, and then a liquid jet (in particular of water) or a laser beam is used to cut through the plurality of stacked sheets simultaneously so as to obtain a plurality of masks that are identical, and where appropriate that are extended by strips or extender portions; alternatively, that document proposes cutting along the outline of the mask by flame cutting, by die cutting, or by plasma cutting.

That method of preparation is well adapted to obtaining a large quantity of identical masks; nevertheless, it is desirable to propose other methods of making such masks, in particular methods that are adapted to making single painting masks on demand.

Known machines and methods for cutting sheet material, such as those described in U.S. Pat. Nos. 4,825,555, 4,725,961, and 4,909,884, are designed to cut skins or thick multilayer materials, and they are not suitable for cutting a sheet material that is thin and fragile.

The present invention satisfies those requirements.

An object of the invention is to propose a method and an apparatus enabling painting masks to be made, which method and apparatus are improved and remedy at least in part the drawbacks of previously known methods and devices.

An object of the invention is to provide a method and an apparatus enabling painting masks to be made from a thin sheet material, which method and apparatus are compatible with the large variations in temperature and humidity that are to be encountered in motor vehicle repair shops.

An object of the invention is to provide a method and an apparatus enabling painting masks to be made from fragile sheet material without tearing the resulting masks and/or the sheet material used.

An object of the invention is to provide a method and an apparatus enabling painting masks to be made while minimizing unusable sheet material scrap.

An object of the invention is to provide a method and an apparatus enabling painting masks to be made accurately and quickly,

Another object of the present invention is to propose a method and an apparatus that are especially designed to make singly and on demand masks for protecting any motor vehicle “glazed” portion, whether plane or rounded, and in particular of any vehicle for road, air, or rail transport.

Another object of the invention is to propose improved painting masks.

In a first aspect, the invention provides a method comprising the steps of:

a) presenting a sheet material over a sheet material support;

b) holding the sheet material in contact with a face of the sheet material support;

c) cutting a mask out in the sheet material held in contact with the sheet material support by using a cutter tool that is moved relative to the support and/or the material, preferably in interrupted manner to leave connecting portions between the periphery of the mask and the sheet material surrounding the mask; and

d) separating the mask from the sheet material and/or the support.

In another aspect, the invention provides device for making a mask from a sheet material, the device comprising:
a sheet material support;
holder means for temporarily holding the sheet material in contact with the support;
cutter means for cutting out a mask from the material held against a face of the support, the cutter means being associated with displacement means for establishing relative displacement between a cutter tool and the support and/or the sheet material;
preferably means for controlling the displacement and/or interruption of the cutter means to cause cutting to be discontinuous, thereby leaving connecting portions between the periphery of the mask and the sheet material; and
preferably feed means for placing the sheet material over the support, and where appropriate separator means for separating the mask—and the scrap it any—from the sheet material support.

In order to avoid or reduce the probability of crumpling or tearing the sheet material and/or the mask, the cutter tool is preferably moved relative to the support at a travel speed situated in a range of 0.01 meters per second (m/s) to 1.00 m/s, and more preferably situated in a range of 0.05 m/s to 0.50 m/s.

In order to make it easier to shape a mask to a portion that is to be protected and in order to reduce the cost of scrap, it is preferable to use a single layer sheet material having a weight per unit area lying in the range 40 g/m² to 90 g/m², and more preferably situated in a range of 50 g/m² to 90 g/m², in particular close to 60 g/m² to 70 g/m².

In order to facilitate and accelerate control of the cutter tool, a collection of masks suitable for a determined vehicle are displayed on a display apparatus, one or more masks are selected from the collection, a configuration for relative positioning of the selected masks is determined that will lead to the amount of scrap being small, and the masks are cut out in this configuration.

Preferably, a vehicle is selected from a collection of vehicles, data corresponding to a collection of masks adapted to the selected vehicle is read from a geometrical database for masks and/or vehicle glazed portions, and said data is used to display said collection of masks.

In other aspects of the invention:
while a mask is being cut out, the sheet material is moved relative to the support, preferably at a speed that is slower than the travel speed of the cutter member relative to the support in order to minimize the risks of tearing; also for this purpose, it is preferable to use a cutter blade that is mounted to pivot freely relative to a moving blade support about an axis that is substantially perpendicular to the support and/or the sheet material;
the blade is moved relative to the sheet material along at least three or four axes or directions;
a support is used that presents a removal portion disposed downstream from a cutting zone, said removal portion sloping downwards to encourage precut masks to move downwards together with scrap sheet material; and
the sheet material is kept in contact with the support both by suction and by pinching between presser rollers for driving the sheet material.

In order to make it easier to separate a mask as precut in this way from the sheet material, interruptions are provided regularly while cutting along the outline of the mask, such interruptions preferably being such that the ratio of the length of a connecting portion over the length of the mask outline between two adjacent connecting portions lies in a range 3×10⁻³ to 3×10⁻¹, and preferably in a range 5×10⁻³ to 2×10⁻²; these interruptions in the cutting that correspond to the connecting portions are preferably made by disengaging the cutter tool from the sheet material by moving the cutter tool away from the material.

In another aspect, the invention provides a painting mask for masking a portion of a motor vehicle, the mask being suitable for being obtained by a method as defined above, and presenting a generally curvilinear outline that is slitted.

In another preferred embodiment:

a1) the sheet material is presented over a sheet material support; and

a2) at least one physicochemical property of the sheet material and/or its packaging is detected or measured, and then it is verified whether the detected or measured property corresponds to a predetermined property and, if so, operations b) to d) as defined above are performed.

To this end, the device of the invention further comprises:
means for detecting and/or measuring a physicochemical property of the sheet material and/or of its packaging, and comparator means connected to the detection and/or measurement means to compare the detected or measured property with a predetermined property; and
validation means connected to the comparator means so that when the detected or measured property corresponds to the determined property, actuation of at least a portion of the apparatus is authorized, in particular actuation of the holder means and/or the cutter means is authorized.

By comparing a measured property of the sheet material with a predetermined value or characteristic for said property, this makes it possible to verify whether the material used is suitable for making a painting mask under good conditions; the invention also makes it possible to avoid the damage to the mask cutter machine that could result from using a material that is unsuitable for this purpose.

The property of the sheet material for detection or measurement may be selected in particular from the dimensions of the material (in particular its thickness), and from its light transmittance at one or more wavelengths in the visible, infrared, ultraviolet, or X-ray domains; and for this purpose the machine includes an optical or an electromechanical detector or sensor adapted to detecting or measuring said property.

Alternatively or in addition, the property for detection may be a mark, a sign, or an object placed on (or secured to) the material or its packaging; in particular it might comprise a watermark, a notch provided along an edge of the material, a perforation in the material, or a thread or strip secured to the material and detectable by optical and/or magnetic detector means.

The predetermined characteristic or value for the detected or measured parameter may be data recorded in a memory of a computer that is integrated in or connected to the machine, or it may be embodied by an electrical or electronic circuit (such as a threshold sensor) connected firstly to the sensor or the detector of said property and secondly to at least one actuator of the cutter machine.

The separator means preferably comprise inhibitor means for deactivating the holder means: the sheet material can be held against the support by the action of holder means that operate mechanically, electro-magnetically (in particular electrostatically), or by means of fluids.

The mechanical holder means may comprise a clamp or a roller co-operating with the support to clamp a portion of the sheet material extending between the clamp and the support; such holder means are preferably movable from a holding position in which they press the material against the support, and a separation position in which they allow the material to slide over the support.

Electrostatic holder means may include a bipolar electrical voltage source having a first terminal presenting a first polarity connected to the material (or to a first moving clamp portion), and a second terminal presenting a second polarity opposite to the first and connected to the support (or to a second moving clamp portion); such electrostatic holder means can be inhibited by disconnecting the source and putting the terminals into electrical connection by means of an electrical conductor (i.e. by short-circuiting).

Fluid holder means may comprise a vacuum pump or a rotary machine (in particular a fan) suitable for establishing (air) suction in a suction duct, together with orifices provided through the sheet material support and opening out firstly in the bearing face of the support and secondly in the suction duct or in a face of the support that is put into communication with said duct; such holder means are particularly suited to holding a single thickness of sheet material on the support.

Preferably, the operation of the apparatus, in particular of the holder means, the cutter means, and the means for moving a cutter tool, is under the control of an electronic unit operating under the control of a program that can be parameterized.

Also preferably, the system including the apparatus, the electronic control unit, and the program, further comprises a geometrical database for the outlines of “glazed” portions of vehicles; in which case, the system preferably includes means for inputting a setback value, which value enables a program in the system to determine an outline for a mask from an outline for the “glazed” portion.

In order to determine a plane outline for a mask that is suitable for a rounded (non-plane) glazed portion, the system preferably includes a program for calculating a flat surface corresponding to a rounded outline; where such a program makes it possible to set up a two-dimensional geometrical database of approximate mask outlines on the basis of a three-dimensional geometrical database of glazed portions.

Preferably, the setback value is determined by a program of the system, and where appropriate is adjusted by an operator, and it lies in a range of values of 10 millimeters (mm) to 45 mm, and in particular in a range 10 mm to 35 mm.

In another aspect of the invention, in order to make it easier to apply a mask onto a rounded “glazed” portion, the mask is slit from its outline towards its center so as to obtain at least-one slit separating two adjacent peripheral portions of the mask; when the mask is pressed against the glazed portion, the two peripheral portions can be superposed prior to being covered in adhesive in order to improve the paint-proofing of the mask.

Also preferably, the material is used of the kind described in document WO 02/29767, which material is packaged in the form of a roll having a length of not less than 100 meters (m) to 200 m and a width of about one meter; furthermore, in order to make it possible to see through a glazed portion that has been covered in a mask, it is preferable for the mask to be made out of a material that is transparent or translucent.

An appropriate length of the material is unrolled over a support (such as a table) which is preferably rounded and pierced by orifices in the form of slots for pneumatically holding (by suction) the material against the support; in some cases, a plane support and/or a cylindrical drum or roller can be used; a mask is cut out by means of a cutter blade which moves relative to the support along at least two or three axes or directions.

Other advantages and characteristics of the invention will be understood from the accompanying claims and from the following description which refers to the accompanying drawings and which relates to preferred embodiments of the invention without the invention being limited thereto.

Unless stated to the contrary, elements that are identical or similar are identified by numbers that are identical,

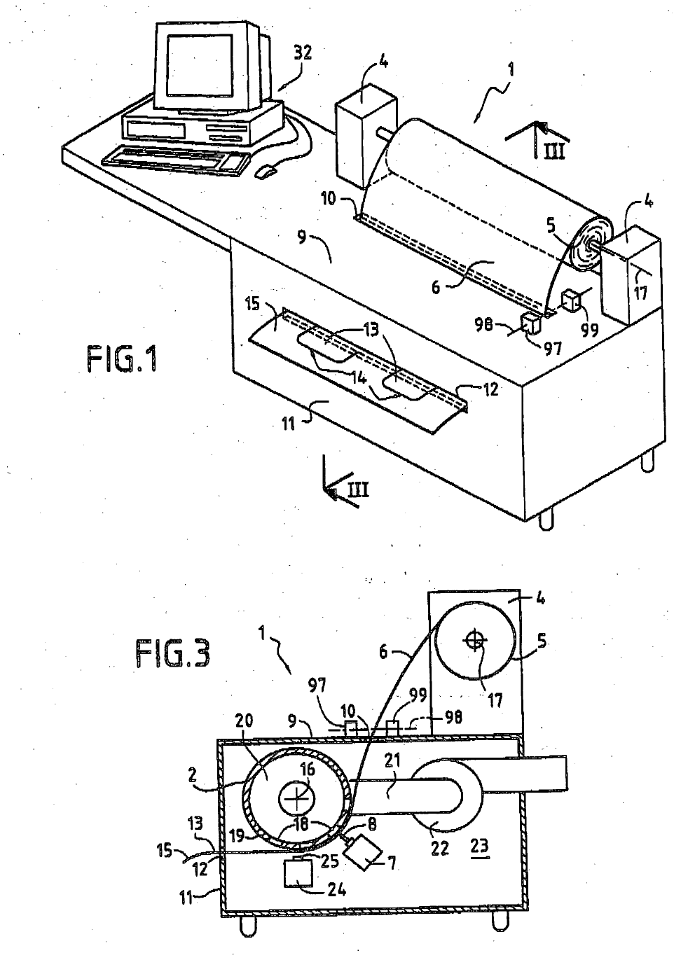

FIGS. 1 and 3 are diagrams of an apparatus constituting a first embodiment of the invention; FIG. 1 is a perspective view of the apparatus and FIG. 3 is a section view on III-III in FIG. 1.

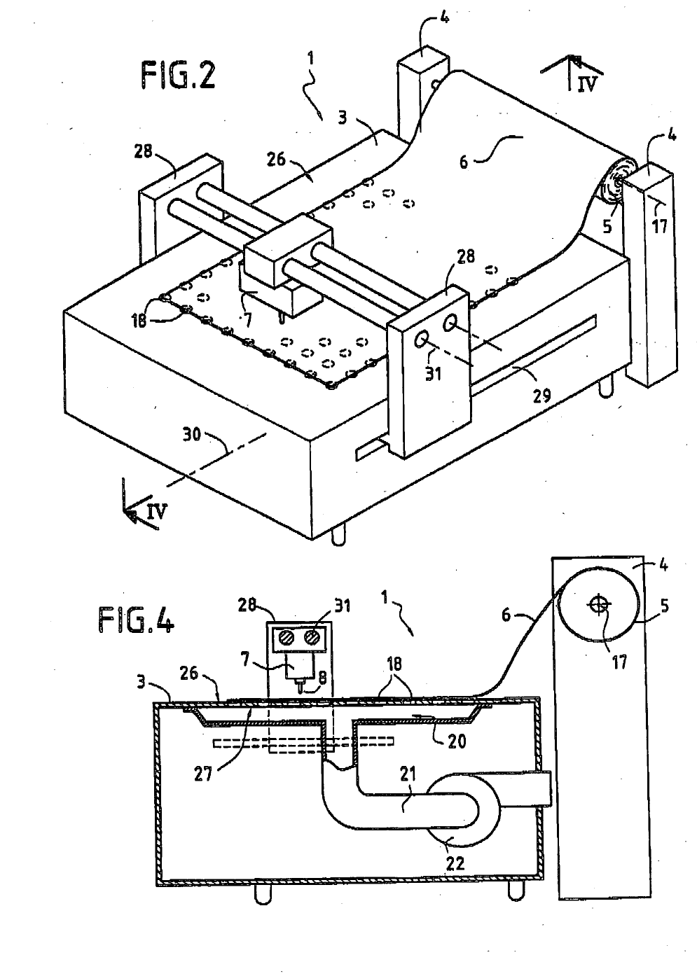

FIGS. 2 and 4 are diagrams showing an apparatus in a second embodiment of the invention; FIG. 2 is a perspective view of the apparatus and FIG. 4 is a section view on IV-IV of FIG. 2.

FIG. 5 is a diagrammatic section view showing the use of a mask as obtained by the method of the invention for the purpose of protecting a vehicle headlight glass.

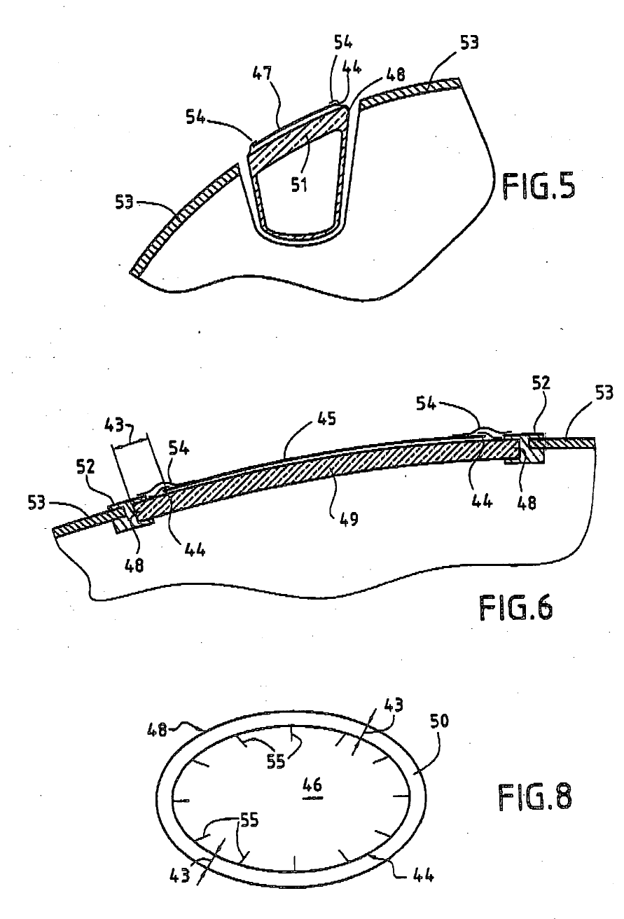

FIG. 6 is a diagrammatic section view showing the use of a mask obtained by a method of the invention for protecting a rounded glazed portion of a vehicle.

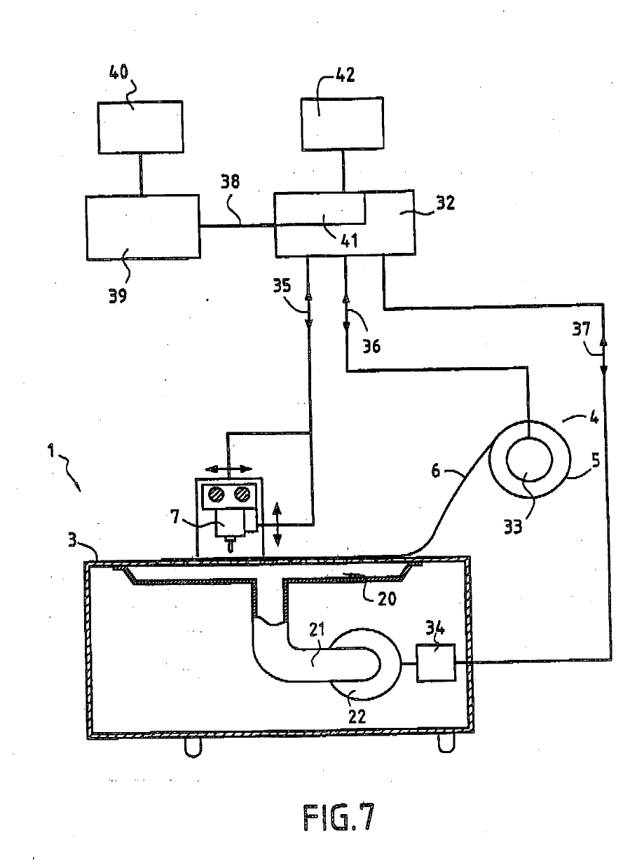

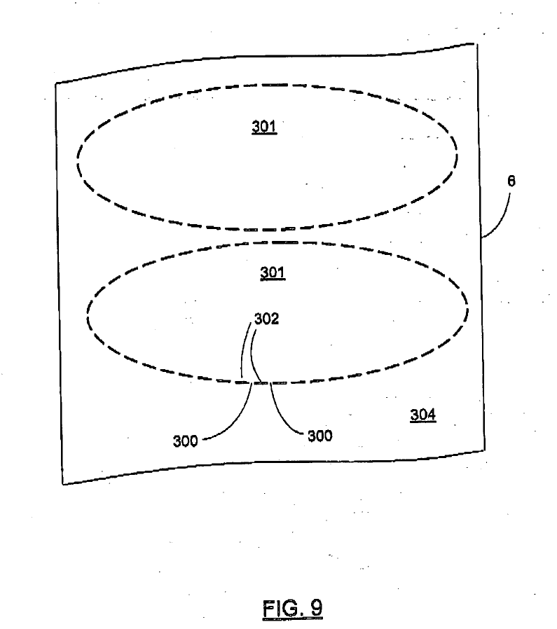

FIG. 7 is a diagram showing the main components of a system for making a mask in accordance with the invention.

FIG. 8 is a diagrammatic front view showing a mask having an outline that is incised (slitted) put into place on an ovoid part to be protected.

FIG. 9 is a diagrammatic front view of two masks of slitted outline obtained in accordance with the invention.

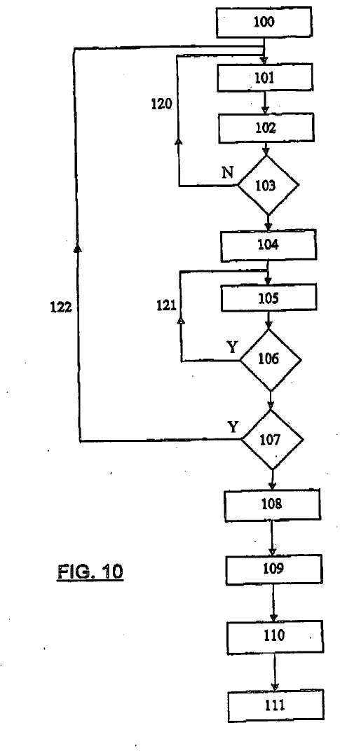

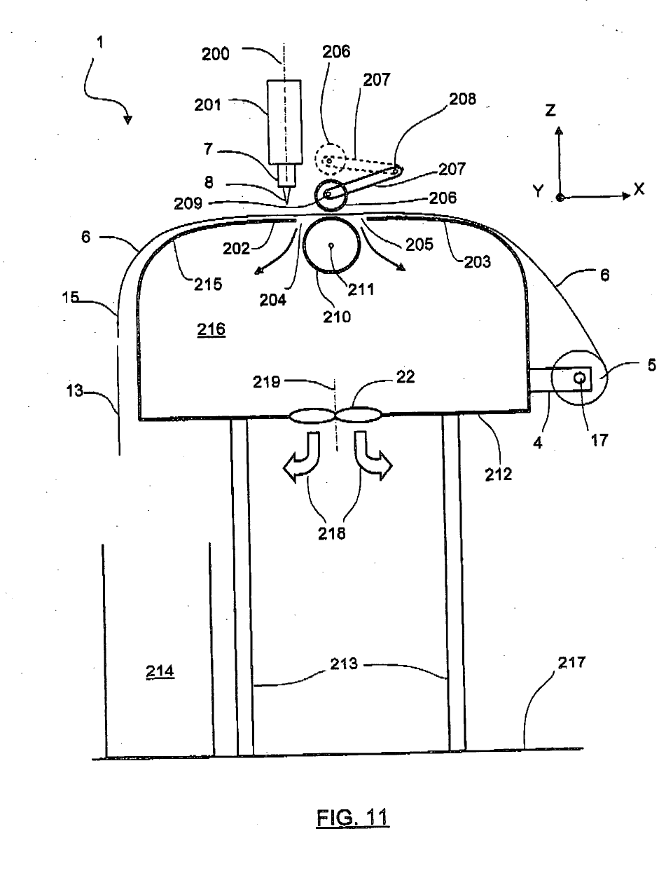

FIG. 10 is a flow chart showing the main steps in a method of the invention.

FIG. 11 is a diagram showing an apparatus in a preferred embodiment of the invention.

With reference to FIGS. 1 to 4 and 7, the apparatus 1 comprises a support comprising a plane table 3 or a cylindrical drum 2; the apparatus 1 also comprises a support 4 for a roll 5 of grease-proofed paper 6, and a cutter tool 7 fitted with a blade 8 and mounted to move relative to the support 2, 3.

In the embodiment shown in FIGS. 1 and 3, a horizontal panel 9 separating the roll 5 from the drum 2 is pierced by a rectilinear slot 10 through which paper 6 unrolled from the roll 5 passes towards the drum and the cutter tool 7, 8; similarly, a vertical front panel 11 is pierced by a rectilinear slot 12 for passing masks 13 that have been cut out along at least a fraction of their outlines 14 in the paper 6 by the tool 7, 8, together with the portion 15 of the paper 6 that surrounds the masks 13 and that constitutes scrap.

In this embodiment, the respective axes of rotation 16 and 17 of the drum 2 and of the roll 5 are horizontal and parallel; a portion of the cylindrical wall of axis 16 defining the hollow drum 2 is pierced by orifices 18 putting the outside face 19 of said portion of the wall into communication with the cavity 20 inside the hollow drum; this cavity is connected by a duct 21 (shown in part) to the suction orifice of a compressor 22 which, when set into operation, establishes suction (relative to the generally atmospheric pressure that exists inside the compartment 23 of the apparatus) inside the cavity 20; as the result of this suction, a portion of the strip of paper 6 extending in the vicinity of the pierced portion of the drum wall is pressed and held in place against the outside face 19 thereof.

Having the paper held against the drum in this way enables the cutter tool 7 to cut out a mask accurately and quickly from the paper; for this purpose, the blade 8 of the tool is moved relative to the paper following the outline of the mask that is to be cut out; this movement is controlled by a computer as described in greater detail below; the relative displacement between the blade 8 and the paper 6 can be the result of the blade 8 and/or the tool 7 moving on its own, or else of the combined displacement of the blade and of the paper (and thus of the rotary drum 2).

A device 24 for marking visible signs on a face of the mask is also incorporated in the apparatus; this device may comprise a nozzle 25 for projecting ink onto the paper, or a tool (not shown) for marking or punching the mask in dry manner.

In the embodiment shown in FIGS. 2 and 4, the top of the table 3 that receives the strip of paper is pierced by a multitude of orifices 18 that perform the same function as that described above relating to the drum, i.e. holding the paper 6 against the outside face 26 of the table 3 by suction being established beside the inside face 27 of the table top 3 inside the cavity 20 that is connected to the suction unit 22 by the duct 21.

In this embodiment, the cutter tool 7 is suspended from a gantry 28 mounted to move in translation on rails 29 that extend along a horizontal axis 30, along two opposite sides of the rectangular table 3; the tool 7 is also mounted to move in translation relative to the gantry 28 along a horizontal axis 31 perpendicular to the axis 30.

Actuators (not shown), in particular electric motors, serve to move the cutter blade 8, the cutter tool 7 fitted with the blade 8, and the gantry 28, as a function of control signals delivered by a computer 32 (FIGS. 1 and 7).

In both of the embodiments shown in FIGS. 1 to 4, the area of the face of sheet material that is pressed against the support (2 or 3) can be smaller than the area of a mask that is to be made, thereby enabling the apparatus 1 to be more compact; under such circumstances, a mask can be made by cutting out a first portion of the mask, then causing the sheet material to move (advance) relative to the support, and then cutting out a second portion of the mask in addition to the first portion.

Under such circumstances in particular, the apparatus may include motor-driven rollers for automatically driving the strip of paper as cutting by the cutter tool progresses.

The floor area occupied by the apparatus is preferably less than or equal to 10 square meters (m²), and in particular less than or equal to 2 m² or 3 m².

The means for moving the cutter tool and/or the strip of paper are preferably designed so as to enable a mask to be cut out in one or a few minutes; the time required to make a mask preferably lies in a range of 1 second (s) to 120 s, and more preferably in a range 1 s to 60 s; for this purpose, the travel speeds of the cutter blade and of the paper are maintained in the above-mentioned ranges; in order to avoid or reduce the tearing that can result from such speeds, the cutter blade is preferably mounted to pivot freely.

As shown in FIG. 7, the computer (or electronic unit) 32 is connected respectively to the cutter tool 7 and to the actuators (not shown) serving to move the tool 7 and to a motor 33 for unrolling the roll 5, and also to a motor 34 for driving the suction unit 22 via electro-magnetic connection means 35 and 37; these connection means serve to convey operating control signals to these members as delivered by the unit 32.

The unit 32 is also connected by telecommunications means 38 (wired or wireless) to another unit 39 or computer; this other unit is connected to a geometrical database 40 concerning the glazed portions of vehicles, for the purpose of transmitting to the computer 32 the geometrical coordinates—in particular those of the outline—of the glazed portion in question after it has read these coordinates from the database 40 in response to a request sent by the computer in association with data identifying a vehicle and/or a determined glazed portion, which request is carried by the means 38.

Since these coordinates are generally in three dimensions, a calculation program 41 responds thereto to determine a two-dimensional outline for a mask that corresponds to said glazed portion and it records the corresponding geometrical data in a database 42 associated with the computer 32.

In order to make the mask in question, another program module of the computer 32 responds to the two-dimensional geometrical data defining the mask outline as read in the database 42 to deliver signals controlling the displacement of the blade of the cutter tool 7, and where appropriate signals for controlling unrolling of the strip of paper and/or signals for advancing and/or reversing the strip of paper on its support.

In order to generate these control signals, account is taken of a distance 43 (FIGS. 6 and 8)—referred to as the “setback” distance—between the edge 44 of the mask 45 to 47 and the edge 48 of the glazed portion 49 to 51 (FIGS. 6 to 8).

This distance 43 is generally selected to be substantially constant over the entire periphery of the glazed portion; the value given to this distance will be comparatively greater when—as shown in FIG. 6—the periphery of the wall 49 to be protected is engaged in a section member 52 surrounding the wall; in contrast, it will be smaller when the glazed portion to be protected is immediately adjacent to the wall 53 that is to be painted, as shown in FIG. 5.

The value of this distance is preferably “adjustable” by an operator inputting a value into the computer 32 for this purpose; this enables the shape of the mask to be optimized as a function of the width of an adhesive tape 54 used by the operator for securing the periphery of the mask to the periphery of the corresponding glazed portion.

In addition, the system can cause the cutter blade to make one or more slits 55 (FIG. 8) in the periphery of the mask, these slits making it easier to establish intimate contact with the periphery of the glazed portion that is covered by the mask; the shape(s), the number, the location(s), and the length(s) of the slit(s) can be calculated by the computer 32 in particular as a function of the geometry of the rounded surface to be protected; these parameters may also be defined or adjusted by the operator, in particular as a function of the mechanical characteristics of the sheet material used for making the masks.

The masks are preferably made from a sheet material that is thin, lightweight, translucent or transparent, and provided on both faces with good resistance to penetration by water- or oil-based substances, such as grease-proof paper or a plastics material presenting suitable electrostatic properties (strong electrostatic power).

As shown in FIGS. 1 and 3, the apparatus includes a light source 97 emitting an optical inspection light beam propagating along an axis 98, and also includes a light receiver 99 that is sensitive to the radiation emitted by the source 97 and situated on the axis 98 which extends through the paper 6 close to its edge; the receiver 99, and where appropriate the emitter 97, is/are connected to the computer (32, FIG. 7) for monitoring and controlling the operation of the machine; this system enables at least one optical parameter of the paper 6 to be monitored (opaqueness or the presence of marks or notches along the edge), by transmitting measurement signals output by the sensor 99 to the computer 32 and by comparing a value (e.g. amplitude or frequency) characteristic of said measurement signal with a reference value recorded in a memory associated with the computer.

Preferably, rotation of the drum 2 and of the roll 5 of paper are controlled so as to ensure that a portion of the strip of paper 6 extending over the cutter member 8 is put under tension, thereby making it easier to cut the paper accurately.

To this end, the apparatus may include a brake in order to slow down rotation of the roll 5.

The paper tensioning means may also comprise one or more additional roller(s) (not shown) for driving the paper and of axis parallel to the axes 1, 17, and extending along the drum 2 in contact with a generator line of the outer envelope of the drum 2; said means may also comprise two rollers disposed between the drum 2 and the roll 5, e.g. in the vicinity of the slot 10; since these rollers extend on either side of the strip 6 and are in contact therewith via respective ones of their substantially-coinciding generator lines, braking the rotation of these rollers tensions the portion of the strip 6 that is situated between them and the paper drive drum 2.

In the embodiment shown in FIGS. 2 and 4, the paper for cutting can also be tensioned by the presence of suction cups and/or a (downstream) drive roller and an (upstream) brake roller for engaging the paper.

With reference to FIG. 11, the apparatus 1 comprises a support 212 standing on the ground 217 via legs 213; walls of the support 212 define a cavity 216 which is maintained at a pressure below ambient air pressure by the action of a fan 22 driven to rotate about an axis 219, sucking air from the cavity 216 and expelling air in the direction of arrows 218.

A gantry 4 secured to the structure 212 supports a roll 5 of paper mounted to rotate about the axis 17 relative to the gantry 4.

The top walls of the structure 202 and 203 of the structure 212 define a longitudinal slot extending parallel to the axis Y; a roller 210 mounted to rotate about an axis 211 parallel to the axis Y subdivides this slot into two slots 204 and 205 parallel to the axis Y; this roller has a top generator line extending level with the edges of walls 202 and 203 for supporting the paper 6 in the vicinity of the cutting zone that extends over the wall 202 close to the slot 204.

A blade 8 supported by an element 7 is mounted free to rotate about an axis 200 parallel to a vertical axis Z and extends over the paper-cutting zone; the blade support 7 is mounted to move in translation relative to a support 201 along the axis 200, in order to enable the blade to engage the paper and to be disengaged therefrom; the support 201 is mounted to move in translation along an axis parallel to the axis Y relative to the stationary structure 212 by means of a gantry similar to that shown in FIG. 2; the blade can thus move along three axes relative to the support 202, 212.

A roller 206 is also provided to drive the paper 6 to slide over the walls 202, 203 along an axis parallel to X, in co-operation with the roller 210 over which it extends; to this end, the roller 206 is mounted to rotate about an axis 209 parallel to Y, at the end of an arm 207 which is itself hinged about an axis 208 parallel to Y and driven by an actuator (not shown) to move relative to the stationary structure 202, 203, 212; by means of this hinge, the roller 206 can pass from a configuration in which it drives the paper by friction between the paper and the rollers 206 and 210—one of which is rotated in order to drive the paper along the axis X-, to a configuration in which the paper is free to slide over the support 202, 203, 210, corresponding to the position of the elements 206 and 207 drawn in dashed lines.

The paper is held in the cutting zone under the blade 8 by sucking air through slots 204, 205 and by clamping between the rollers 206 and 210, with these rollers also serving to drive the paper along the axis X. The structure 212 also has a portion 215 of the wall extending the cutting surface 202 and sloping downwards so as to make it possible downstream from the zone 202 for masks 13 and paper scrap 15 to fall away into a container 214.

By making connecting portions at the periphery of a mask, it is possible to keep the scrap together with the masks for subsequent separation; this makes it easier to expel the scrap and the masks from the cutting zone and makes it possible to avoid pieces of scrap accumulating in said zone under the effect of the suction; these connecting portions are obtained by interrupting cutting of the paper by lifting the blade along the axis 200 by means of an actuator controlled by a computer that controls cutting (not shown).

As shown in FIG. 9, the length—measured along the outline of the mask 301—of a connecting portion 300 between two successive portions 302 of cut outline is much shorter than the length of each of said cut portions, so as to make it easier subsequently to separate the mask 301 from the scrap 304 surrounding it; by way of example, the length of a connecting portion 300 may lie in the range 0.1 mm to 3 mm, while the length of each cut portion 302 extending between two connecting portions may lie in the range 5 mm to 100 mm.

With reference to FIG. 10, the method of cutting out individual masks on demand comprises the following operations in succession;
an initialization step 100 serving in particular to allow the computer to verify that a determined kind of paper is present engaged between the drive rollers of the cutter machine;
a step 101 of inputting identity data for a vehicle model for which one or more painting masks are desired;
a step 102 of interrogating a geometrical database concerning masks and/or glazed portions of vehicles;
a test 103 for testing the result of a search performed in the database; when this test is negative (N), execution returns to step 101 (branch 120), and the operator is invited to input other vehicle identity data; otherwise, the test is positive and execution continues with:
step 104 of displaying on a display device under the control of the computer, the nature and/or the shape of the masks or the glazed portions that have been found in the database and that correspond to the vehicle in question;
a step 105 of inputting data identifying a painting mask that is to be cut out, and the quantity of such masks that are desired;
if several types of mask are desired for the vehicle (test 106—branch 121), step 105 is repeated; in a variant implementation, steps 104 to 106 are replaced by a step of automatically selecting the masks that are to be made for the vehicle in question as a function of data (which might be keyed into the computer) identifying a zone of the vehicle that has suffered an impact; depending on the position of the impact zone, a program determines which glazed portions are close to the zone and require masks to be made therefor;
if it is desired to make masks for some other model of vehicle (test 107 branch 122), data for selected masks is recorded and execution returns to step 101;
otherwise, the geometrical data for all of the masks that are to be made is used to determine a cutting configuration that enables scrap to be minimized (step 108);
displacement of the blade and of the paper is then controlled in a step 109 until all of the desired masks have been precut; in order to obtain cutting that is fast and accurate without leading to tearing, the displacement speeds of the blade and of the paper drive rollers are maintained within the ranges specified above; and
it is possible for each mask to be marked in a step 110 prior to being delivered in a step 111 and the machine being stopped.

1-35. (canceled)

36. A method of making a painting mask (13, 45 to 47, 301) for masking a portion of a vehicle, the method being characterized by the following steps:
a) presenting a sheet material (6) over a sheet material support (2, 3, 202, 210);
b) holding the sheet material in contact with a face (19, 26) of the sheet material support;
c) cutting a mask out in the sheet material held in contact with the sheet material support by using a cutter tool (7, 8) that is moved relative to the support and/or the material; and
d) separating the mask from the sheet material and/or the support.

37. A method according to claim 36, in which the mask is cut out in interrupted manner so as to form connecting portions (300) between the periphery of the mask and the sheet material surrounding the mask.

38. A method according to claim 36, in which the cutter tool is moved relative to the support at a displacement speed lying in the range 0.01 m/s to 1.00 m/s.

39. A method according to claim 38, in which a sheet material (6) is used presenting weight per unit area of less than 200 g/m².

40. A method according to claim 36, in which a display device used to display (104) a collection of masks adapted to a given vehicle, in which one or more masks is/are selected from the collection of masks, in which a configuration for relative positioning of the selected masks is determined (108) so as to achieve an amount of scrape that is small, and in which the masks are caused to be cut out (109) in this configuration.

41. A method according to claim 40, in which one vehicle is selected from a collection of vehicles, and in which data corresponding to a collection of masks adapted to the selected vehicle is read from a geometrical database of masks and/or vehicle glazed portions, and said data is used to display said collection of masks.

42. A method according to claim 36, in which the sheet material is moved relative to the support at a speed that is slower than the speed of the cutter tool.

43. A method according to claim 36, in which the blade is moved relative to the sheet material along at least four axes or directions.

44. A method according to claim 43, in which a blade is used that is free to pivot about an axis (200) substantially perpendicular to the support and/or the sheet material.

45. A method according to claim 37, in which the ratio of the length of a connecting portion (300) to the length of mask outline (302) between two adjacent connecting portions lines in a range 3×10⁻³ to 3×10⁻¹.

46. A method according to claim 36, in which at least one physicochemical property of the sheet material and/or its packaging is detected or measured, after which it is verified whether the detected or measured property corresponds to a predetermined property, and if so, operations b) to d) are performed.

47. A method according to claim 36, in which the sheet material is held in contact with the support by pneumatic suction and by applying pressure.

48. A method according to claim 36, in which the sheet material is moved relative to the support under drive from presser rollers.

49. A method according to claim 36, in which the sheet material packaged in the form of a roll is unrolled so as to be presented over a downwardly-curving table (3).

50. A method according to claim 36, in which a single thickness of sheet material is cut out at a time by means of a blade (8), the blade being moved along at least two or three axes or directions relative to the support.

51. A method according to claim 36, in which the length of time required for cutting out a mask lies in a range of 1 s to 120 s.

52. A method according to claim 36, in which a mask is cut out in such a manner that its outline (44) is set back (43) from the outline (48) of the portion of the vehicle that is to be protected, with the value of the setback (43) being adjusted, if appropriate.

53. A method according to claim 36, in which one or more slits (55) are cut from the edge (44) of the mask.

54. A method according to claim 36, in which at least one item identifying the vehicle and/or the operator concerned is marked and/or printed on the mask.

55. A painting mask for masking a glazed portion of a vehicle as obtained by a method according to claim 36, the mask presenting a slitted outline.

56. A mask according to claim 55, presenting a weight per unit area lying in a range 50 g/m² to 80 g/m², having one or more slits (55) extending from its edge (44) towards its central portion, in which the outline is curvilinear at least in part and which is made from a sheet of material that is thin, lightweight, translucent or transparent, and provided on both faces with good resistance to penetration by a water- or oil-based substance.

57. Apparatus (1) for making a painting mask (13, 45 to 47, 301) for masking a portion of a vehicle out of a sheet material (6), the apparatus comprising:
a sheet material support (2, 3, 202, 210);
holder means (18, 20, 21, 22, 206, 207) for temporarily holding the sheet material in contact with the support; and
cutter means (7, 8) for cutting out a mask from the material held against a face of the support, the cutter means being associated with displacement means (28, 29) for establishing relative displacement between a cutter tool (8) and the support and/or the sheet material.

58. Apparatus according to claim 57, including means for causing a mask to be cut out discontinuously along its outline.

59. Apparatus according to claim 57, including a downwardly-curved table (202, 215) and a roller (210) for supporting the sheet material, the table being pierced by orifices (204, 205) in the form of slots extending on either side of the roller (210).

60. Apparatus according to claim 57, including means (22) for establishing suction in a cavity (216) in communication with the orifices (204, 205), and means (206, 207) for applying pressure and driving the sheet material by friction against a roller (210).

61. Apparatus according to claim 57, including means for detecting and/or measuring a physicochemical property of the sheet material and/or of its packaging, comparator means connected to the detection and/or measurement means to compare the detected or measured property with a predetermined property, and validation means connected to the comparator means so that when the detected or measured property corresponds to the determined property, actuation of at least a portion of the apparatus sis authorized, in particular actuation of the holder means and/or the cutter means is authorized.

62. Apparatus according to claim 57, and including:
an electronic unit (32) connected to actuators for displacing the cutter tool (7, 8); and
a program for controlling the cutter tool and its displacement as a function of two-dimensional or three-dimensional geometrical data concerning masks or glazed portions that are recorded in a database (40, 42) connected to the unit (32).

63. Apparatus according to claim 57, including means for adjusting a setback (43) between the edge (44) of a mask and the edge (48) of a portion to be masked.

64. Apparatus according to claim 57, and including:
an electronic unit (32) connected to actuators for displacing the cutter tool (7, 8);
an optical sensor (99) connected to the electronic unit to deliver signals thereto on detection or measurement of an optical characteristic of the paper;
a memory having a reference value recorded therein and associated with the electronic unit; and
program means for comparing the signals delivered by the sensor (99) with the reference value.

65. Apparatus according to claim 57, further comprising:
means for inputting data to identify a zone of a vehicle, such as a zone that has been impacted during an accident involving the vehicle;
selector means for automatically selecting one or more glazed portions of the vehicle that need to be masked, as a function of the identification data; and
control means for controlling the cutter means to make one or more masks adapted to the selected glazed portion(s).
